(19) United States
(12) Patent Application Publication
(10) Pub. No.: US 2026/0115816 A1
(43) Pub. Date: Apr. 30, 2026

(54) CHAINSAW CHAIN SHARPENING MARKER

(71) Applicant: Everette L. Moritz, Victoria, TX (US)

(72) Inventor: Everette L. Moritz, Victoria, TX (US)

(21) Appl. No.: 19/306,893

(22) Filed: Aug. 21, 2025

Related U.S. Application Data
(60) Provisional application No. 63/714,548, filed on Oct. 31, 2024.

(51) Int. Cl. B23D 63/16; B23D 63/10

(52) U.S. Cl. CPC B23D 63/166; B23D 63/10

(57) ABSTRACT

Apparatus and associated methods relate to a chainsaw sharpening marker system configured to guide sharpening of each tooth using a series of aligned visual marks positioned on the teeth themselves. In an illustrative example, each cutting tooth on a chainsaw chain includes a sharpening marker including a set of marks etched at a predetermined angle that corresponds to the cutting angle of the tooth. The sharpening marker, for example, enables a user to visually align a sharpening tool during operation by referencing both the angle and position of the etched marks relative to the tooth's cutting edge. Various embodiments may advantageously ensure consistent angular sharpening and equal tooth length across alternating left- and right-facing teeth, improving straightness and precision in cutting performance.

### CROSS-REFERENCE TO RELATED APPLICATIONS

This application claims the benefit of U.S. Application Ser. No. 63/714,548, titled “Everette L. Moritz,” filed by Everette L. Moritz on Oct. 31, 2024.

### TECHNICAL FIELD

Various embodiments relate generally to chainsaws, manufacturing chainsaw chains, and chainsaw chain maintenance.

### BACKGROUND

Chainsaws are versatile cutting tools powered by gasoline engines or electricity, designed for a wide range of applications. They consist of a guide bar and a rotating chain with cutting teeth that efficiently cut through materials, primarily wood. Safety features like chain brakes and anti-vibration systems protect users, and regular maintenance ensures safe operation. Chainsaws find uses in forestry, construction, landscaping, and emergency services, with various types available, including standard, arborist, and top-handle models, each suited for specific tasks. Electric and battery-powered options offer eco-friendly alternatives to high-power gasoline models.

Chainsaw chains are important components with sharp cutting teeth on interconnected metal links, rotating rapidly to make precise cuts in wood and other materials. The chain's pitch determines tooth spacing, impacting cutting speed and efficiency, with common pitches like ⅜-inch, 0.325-inch, and 0.404-inch. Different tooth configurations, such as chisel, semi-chisel, and skip-tooth, offer various trade-offs between aggressiveness and durability. Regular chain maintenance, including sharpening and tensioning, is vital for safety and performance. Chainsaw chains play pivotal roles in forestry, construction, and landscaping.

### SUMMARY

Apparatus and associated methods relate to a chainsaw sharpening marker system configured to guide sharpening of each tooth using a series of aligned visual marks positioned on the teeth themselves. In an illustrative example, each cutting tooth on a chainsaw chain includes a sharpening marker including a set of marks etched at a predetermined angle that corresponds to the cutting angle of the tooth. The sharpening marker, for example, enables a user to visually align a sharpening tool during operation by referencing both the angle and position of the etched marks relative to the tooth's cutting edge. Various embodiments may advantageously ensure consistent angular sharpening and equal tooth length across alternating left- and right-facing teeth, improving straightness and precision in cutting performance.

Various embodiments may achieve one or more advantages. For example, some embodiments may reduce user error during manual sharpening. Some embodiments may extend chain life by preventing over-sharpening. Some embodiments may increase cutting accuracy and reduce kickback. Some embodiments may simplify maintenance for less experienced users. Some embodiments may improve training outcomes by providing a visual sharpening reference. Some embodiments may allow rapid visual inspection for wear or replacement thresholds.

The details of various embodiments are set forth in the accompanying drawings and the description below. Other features and advantages will be apparent from the description and drawings, and from the claims.

### BRIEF DESCRIPTION OF THE DRAWINGS

FIG. 1A depicts an exemplary chainsaw sharpening marker employed in an illustrative use-case scenario.

FIG. 1B depicts an exemplary schematic of the chainsaw sharpening marker.

FIG. 2A depicts other embodiments of chainsaw sharpening markers.

FIG. 2B. depicts an exemplary chainsaw sharpening marker.

FIG. 2C depicts a rear side of a chainsaw sharpening marker.

FIG. 3A depicts an exemplary back side of a blade with a sharpening marker embodiment.

FIG. 3B depicts an exemplary lawnmower blade with a sharpening marker embodiment.

FIG. 4 depicts a flowchart illustrating an exemplary uniform chain sharpening method.

Like reference symbols in the various drawings indicate like elements.

### DETAILED DESCRIPTION OF ILLUSTRATIVE EMBODIMENTS

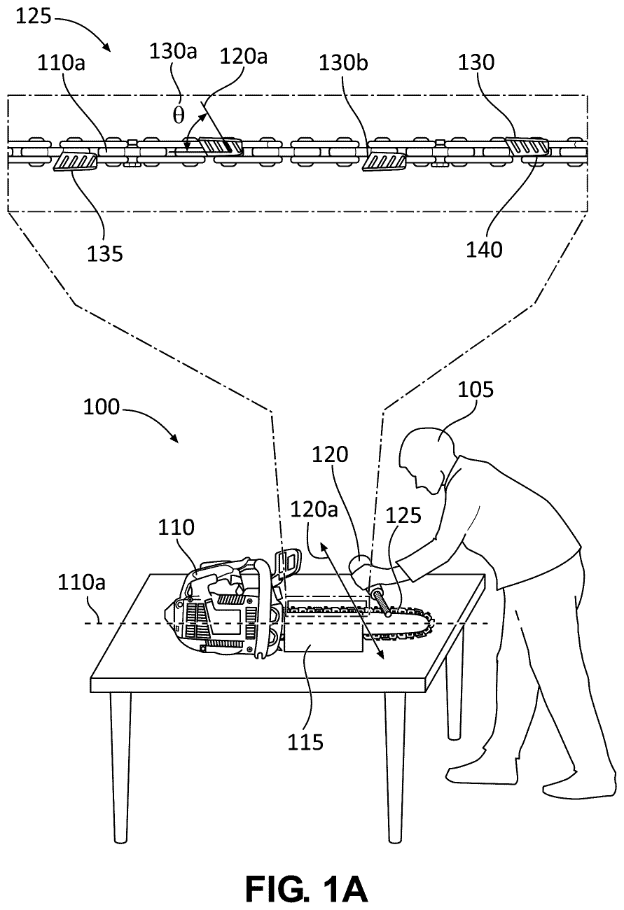

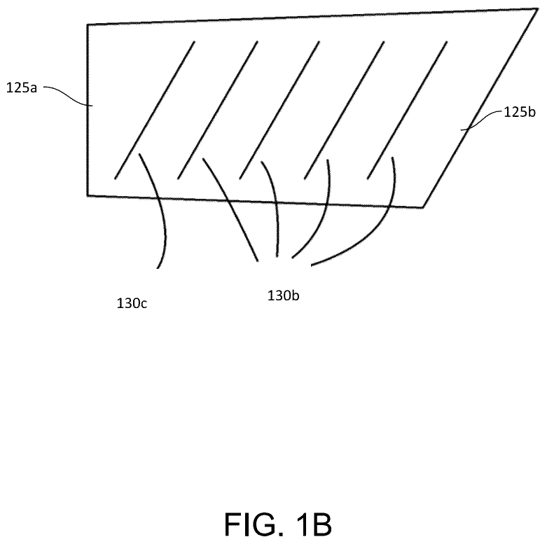

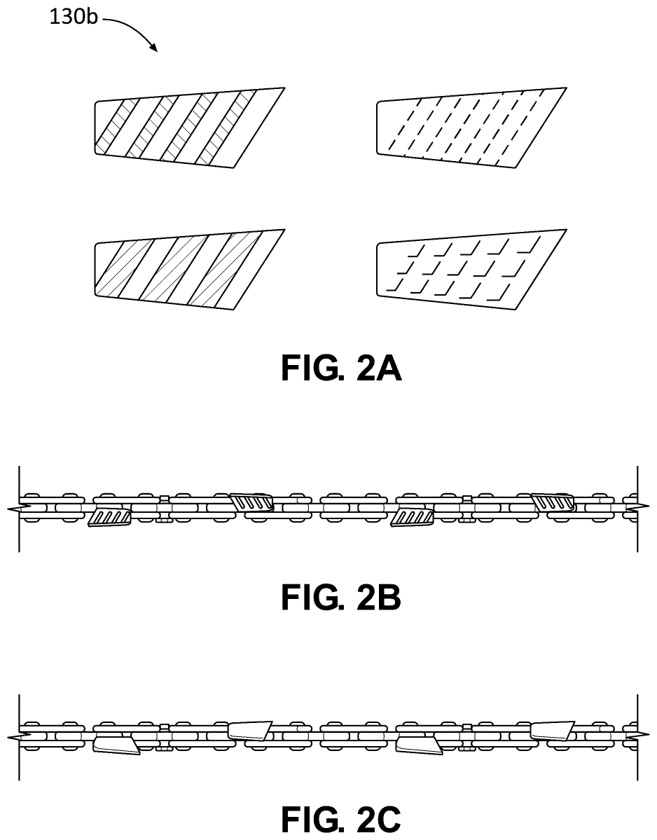

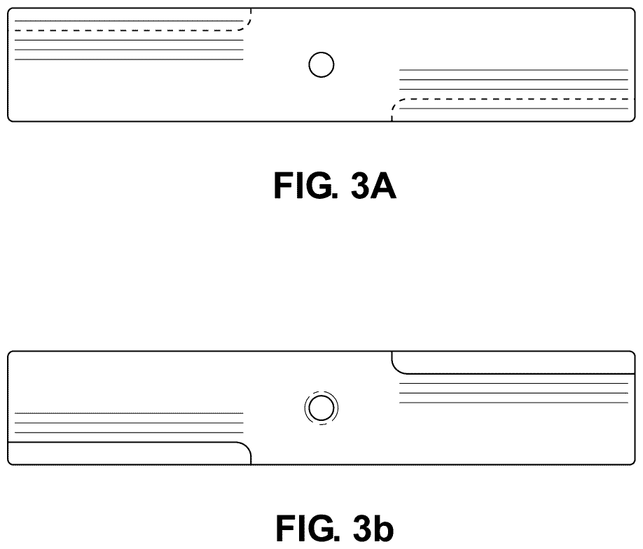

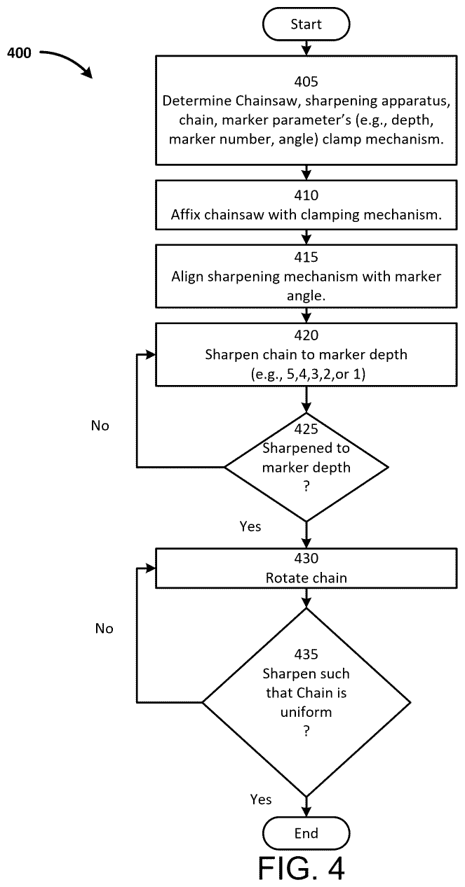

To aid understanding, this document is organized as follows. First, to help introduce discussion of various embodiments, an exemplary chainsaw sharpening marker is introduced with reference to FIGS. 1A-2C. Second, that introduction leads to a description with reference to FIGS. 3A-3B of some exemplary embodiments of knives and lawn motor blades. Third, with reference to FIG. 4, an exemplary method to uniformly sharpen a chainsaw chain is depicted.

Apparatus and associated methods pertain to a chainsaw sharpening marker for a chainsaw chain. The chainsaw marker may include a witness marker. In an illustrative example, each reference mark includes five marks, angled between 25-35 degrees. Each tooth can be divided into a predetermined number of sections, often five or four. The marks may, for example, allow a user to advantageously sharpen the chain saw chain based on the chainsaw marker reading. The user may, for example, sharpen the chain saw chain uniformly based on the chainsaw marker reading. The user may, for example, know the length of time required before replacing his chainsaw blade based on the number of markers left. The user may, for example, know when to replace his chain saw teeth when the user reaches the last marker.

The marks may, for example, be manufactured using laser etching technology to prevent damage to the teeth while marking. The laser etching technology used to manufacture the mark may, for example, allow for the mark to interfere less with the cutting edge. In some embodiments, the marks may take the form include distinctive tooth marks (e.g., include patterns, color, dashes, 2-dimensional dash patterns). The mark may, for example, alternate to correspond to the orientation of the chainsaw chains.

The chainsaw chain includes alternating teeth, with alternating angles, often corresponding to the first and second rows of teeth. The marks align with these alternating angles, enabling users to sharpen the first row and/or side of teeth using a series of marks oriented in one direction and the opposing second row of teeth using marks oriented in the opposite direction, all on the same chain. These marks facilitate uniform sharpening of the chainsaw teeth, ensuring that both rows of chain saw teeth are of equal length.

The process of sharpening with a marking device involves clamping the chainsaw bar into a vice, selecting the first side to be sharpened, determining the appropriate file size, and clamping the file into a guide. Next, the user makes 2-3 strokes per tooth along the full length of the row, with multiple marks helping to prevent uneven lengths and angles. The presence of the mark on each tooth allows the user to more easily ensure uniformity in angle and length. Finally, the user sharpens the second opposing row to match in length until all cutting edges are equidistance to the same reference marker on all the teeth.

FIG. 1A depicts an exemplary chainsaw sharpening marker employed in an illustrative use-case scenario 100. The illustrative user-case scenario 100 includes a user 105. The user 105 is sharpening a chainsaw 110. The chainsaw 110 is being affixed with a clamp 115. The user is using a sharpening tool 120. The chain saw 110 includes a chain saw chain 125. The user 105 is sharpening the chainsaw chain 125 with the sharpening tool 120 by making a motion 120a. The chain saw 110 aligned a longitudinal direction 110a. The chainsaw chain 125 includes a reference mark 130.

The reference mark 130 includes a plurality of distal marks 130b. The reference mark 130 includes a proximal mark 130c (as depicted in FIG. 1B). The reference marks are angled at an angle 130a, as indicated by the theta mark. The angle is formed by the reference mark direction 120a and the chain saw longitudinal direction 110a. The angle may, for example, include 30 degrees. The angle may, for example, include 25 degrees. The angle may, for example, include 35 degrees. The reference marks may, for example, alternate as each tooth of the chain saw chain alternates, so the direction of the sharpening would alternate between intervals. For example, reference mark 135 is directed in a first direction. Reference mark 140 is directed in an opposing direction of the first direction of the reference mark 135.

FIG. 1B depicts an exemplary schematic of the chainsaw sharpening marker 130. The chainsaw marker includes a proximal mark 130c. The chainsaw teeth may, for example, be oriented such that the proximal end witness mark 130c is set a predetermined distance and at a predetermined angle from a proximal end 125a of the chainsaw 125. The chainsaw teeth may, for example, include a distal end 125b distal from the chainsaw 125. Distal witness marks 130b may, for example, be oriented in a similar angle and at set intervals from the proximal mark 130c.

In some embodiments, the chainsaw sharpening mark 130 may, for example, be embedded on each tooth of the chainsaw chain. The mark may, for example, indicate the correct angle for sharpening. Positioned at the far end from the cutting edge, these marks serve as guides. However, over time, as chains are sharpened repeatedly, differences in sharpening pressure often result in one side or row of teeth becoming shorter than the other. This unevenness leads to inefficient cutting, as the saw may cut crookedly or in an arc.

FIG. 2A-2C depicts other embodiments of chainsaw sharpening markers. In some embodiments, the chain saw marker may, for example, be on each tooth to divide it into fourths or fifths. These marks embodiments may, for example, be implemented in various ways, such as extra marks, multi-colored segments on each tooth, or alternating dark and light marks.

The marks may, for example, allow a user to keep the cutting edge always near a reference point, making it easier to discern if the teeth are of equal length. Ensuring uniform length of the teeth on both sides of the chain enables the saw to cut more efficiently and in a straight line. These new marks, designed not to interfere with the cutting edge, could be laser etched onto each tooth.

The marks may, for example, allow a user to sharpen a chain saw uniformly. When sharpening, the user starts from the right end, and as the chain is filed, and metal is removed, the file moves closer to the first of the distal reference marks. This approach allows for more precise sharpening, as the user compares the distance to the closest distal mark 130b rather than guessing the length of the teeth in relation to the proximal 130c mark. The proximal mark 130c may, for example, let a user not sharpen past this point and replace their chain.

The chainsaw marker may, for example, allow a user to significantly reduce the guesswork involved in maintaining equal tooth length, leading to a more efficient and straight cutting performance. By improving the accuracy and ease of sharpening, the chain saw marker may, for example, improve maintenance and enhance both precision and efficiency in sharpening chainsaw chains.

FIG. 3A depicts an exemplary back side of a blade with a sharpening marker embodiment. The blade depicted is the backside of the blade. The reference marks may, for example, be positioned a predetermined distance apart. The predetermined distance may, for example, include ⅛″. The hashed lines depict a sharpening edge on the other side of the blade.

FIG. 3B depicts an exemplary lawnmower blade with a sharpening marker embodiment. The lawn mower blade includes a cutting edge. Sharpening lines may, for example, be aligned at set intervals along the angle of the cutting edge. A user may, for example, sharpen the blade uniformly with the other end of the lawn mower blade, e.g., 4^{th} reference line. A user may, for example, achieve a uniform sharpened lawn mower blade allowing for even grass when grass is cut.

FIG. 4 depicts a flowchart illustrating an exemplary uniform chain sharpening method 400. In step 405, a user determines the chainsaw type, sharpening apparatus (e.g., round files, flat files, battery powered sharpener, sharpening jig, depth, diamond files), marker parameters (e.g., depth, marker number, angle), and clamp mechanism (e.g., vice, clamp, etc.).

In step 410, the user affixes the chainsaw with the clamping mechanism. In step 415, the user aligns the sharpening mechanism with the marker's angle. In step 420, the user sharpens the tooth to a uniform predetermined length (e.g., to the 4^{th} distal reference mark). The user may, for example, only sharpen each end 3 times, but ensured that all refence markers are within a range above the 4^{th} reference mark, above the 3^{rd} distance mark, at the 4 ½ distal mark. The number may, for example, be determined by counting the remaining number of reference marks on the tooth of chain saw. In step 425, the user determines whether the mark has reached the depth. If not, the user continues to sharpen the chain. If so, the user of the method rotates the chain in step 430. In step 435, the user sharpens the chain tooth to the reference mark until the chain is uniformly sharpened. The user may, for example, make 2-3 strokes per tooth along the full length of the row, with multiple marks helping to prevent uneven lengths and angles. If the chain is not uniformly sharpened the user continues to sharpen and rotate the chain until it is sharpened to the reference mark (e.g., reference mark 4). The user may, for example, ensure the cutting edges are equidistant to the same reference marker on each tooth of the chainsaw.

Although various embodiments have been described with reference to the figures, other embodiments are possible.

Although an exemplary system has been described with reference to the figures, other implementations may be deployed in other industrial, scientific, medical, commercial, and/or residential applications. The chainsaw marker may, for example, be used in training exercises. The chainsaw marker may, for example, be used in trade schools to enable users to sharpen their chainsaw teeth uniformly. The chainsaw marker may, for example, be used in kits and sold with chainsaws. The chainsaw marker may, for example, be embedded on chainsaw chains and be sold separately. The chainsaw marker may, for example, be manufactured using a laser etching device. The chainsaw marker may, for example, be used residential to complete yard maintenance. The chainsaw marker may, for example, be used for commercial purposes such as lumbering. The chainsaw marker chain may, for example, be sold in a kit with a chainsaw sharpening tool, and a lubricant.

The chainsaw marker may, for example, be used in other embodiments other than chainsaws. The marker may, for example, be used on blades for uniform sharpening. The marker may, for example, be used on lawnmower blades. The marker may, for example, be used on knives. The marker may, for example, be used on other cutting tools, such as kitchen knives.

In an illustrative aspect, In some embodiments, a chainsaw sharpening marker apparatus may include a chainsaw chain configured to travel along a longitudinal axis. The chain may, for example, include a plurality of cutting teeth alternating in orientation between a first angle and a second angle relative to the axis. A sharpening marker may be disposed directly on each cutting tooth, with each marker including a plurality of aligned marks etched at a predetermined sharpening angle. These marks may, for example, allow a user to visually align a sharpening tool during operation to maintain angle consistency and monitor material removal.

The aligned marks may, for example, be produced using a laser-etching process configured to form permanent surface indications on each tooth without damaging or altering the mechanical integrity of the cutting edge. Laser etching may, for example, be preferred over mechanical marking due to its precision and minimal material disruption.

In some embodiments, each sharpening marker may instead include four aligned marks, spaced evenly along the sharpening angle. These evenly spaced marks may, for example, correspond to successive sharpening intervals, allowing a user to make repeatable, uniform strokes.

In some embodiments, the sharpening marker may comprise five aligned marks, allowing finer granularity for wear tracking or use-cycle measurement. The five-mark configuration may, for example, be desirable in professional or commercial applications requiring frequent sharpening.

In some embodiments, the sharpening angle may, for example, be approximately 30 degrees, although other angles such as 25 or 35 degrees may be used depending on the specific chain geometry. The sharpening markers may alternate between left-leaning and right-leaning across the chain to match the alternating orientations of the teeth.

In some embodiments, the aligned marks may, for example, vary in length such that each successive mark is longer or shorter than the previous one. This variation may, for example, help users visually distinguish wear progression or guide stroke length.

In some embodiments, the final aligned mark in a sharpening marker may act as a wear limit marker. This wear limit may, for example, indicate when a tooth should be retired or replaced, helping prevent over-sharpening and improving safety.

In some embodiments, the sharpening markers may, for example, be applied on both the top and side surfaces of each tooth. The dual-surface visibility may assist users sharpening from various angles or when using different tools (e.g., hand files vs. mechanical sharpeners).

In some embodiments, the sharpening markers on teeth oriented at the first angle may be mirrored in both angle and position relative to the markers on teeth oriented at the second angle. This mirroring may ensure visual consistency for alternating sharpening directions.

Some embodiments of a chainsaw sharpening marker system may, for example, include a chainsaw body with a motor, guide bar, and drive mechanism to rotate the chain. The chain may be affixed with the sharpening marker apparatus, including alternating teeth and corresponding marker sets as previously described.

In some embodiments, the sharpening marker system may include laser-etched markers on each tooth, formed to a controlled depth to preserve cutting edge performance throughout the chain's service life.

The system may, for example, be configured such that each marker includes four aligned marks, allowing a user to visually verify uniform sharpening intervals across multiple teeth.

The system may, for example, alternatively employ five aligned marks to improve sharpening accuracy and provide a higher number of reference points during high-frequency sharpening operations.

The sharpening angle for each marker may, for example, alternate between approximately +30 and −30 degrees depending on tooth orientation, enabling consistent sharpening of alternating left- and right-facing teeth.

In some implementations, each aligned mark within a sharpening marker may vary in line weight, length, or contrast, such that progressive wear on each tooth becomes visibly apparent without measuring tools.

In some embodiments, the final aligned mark may serve as a visual wear indicator, wherein contact with the last mark signals end-of-life for the cutting tooth, helping users avoid continued use of excessively worn teeth.

In some embodiments, the sharpening system may include marker applications on multiple surfaces of each tooth, allowing sharpening from above or from the side. Such dual-surface visibility may, for example, enhance usability in low-light or field conditions.

In some embodiments, the sharpening markers may, for example, be mirrored across opposing teeth, and the system may include alternating marker geometries aligned with the direction of chain movement to promote proper user orientation during sharpening.

In some embodiments, the sharpening marker may include a set of ribbon-like stripes that intersect the sharpening angle. These ribbon stripes may, for example, be spaced to indicate incremental sharpening zones, aiding users in keeping stroke lengths consistent and reducing variability between adjacent teeth.

In other embodiments, the sharpening marker may include a staggered pattern of L-shaped symbols. The L-shapes may, for example, reinforce the desired angular orientation of the sharpening stroke while serving as alignment guides. The staggered pattern may also assist in quickly distinguishing sharpening orientation across alternating teeth.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

1. A chainsaw sharpening marker apparatus, comprising:
a chainsaw chain configured to travel along a longitudinal axis and including a plurality of cutting teeth, the cutting teeth alternating in orientation between a first angle and a second angle relative to the longitudinal axis;
a plurality of sharpening markers, each sharpening marker disposed directly on a corresponding cutting tooth of the chainsaw chain;
wherein each sharpening marker comprises a plurality of aligned marks etched into the surface of the cutting tooth at a predetermined sharpening angle corresponding to the orientation of the tooth;
wherein the aligned marks are positioned such that a first mark is located proximal to a cutting edge of the tooth and at least one subsequent mark is located distal to the cutting edge along the same angular direction;
wherein the aligned marks are disposed at consistent angular orientations for similarly-oriented teeth and at alternating angular orientations for alternately-oriented teeth, configured such that a user visually aligns a sharpening tool with the aligned marks during a sharpening operation to maintain a consistent sharpening angle and to monitor material removal across all cutting teeth.

2. The chainsaw sharpening marker apparatus of claim 1, wherein the aligned marks are laser-etched to a controlled depth that avoids compromising the cutting integrity of each tooth.

3. The chainsaw sharpening marker apparatus of claim 1, wherein the aligned marks comprise one or more series of aligned marks comprising four marks positioned at equal intervals.

4. The chainsaw sharpening marker apparatus of claim 1, wherein the aligned marks comprise one or more series of aligned marks comprising five marks positioned at equal intervals.

5. The chainsaw sharpening marker apparatus of claim 1, wherein the predetermined sharpening angle is approximately 30 degrees and alternates direction with each adjacent cutting tooth.

6. The chainsaw sharpening marker apparatus of claim 1, wherein the aligned marks differ in length to visually indicate a progression of tooth wear.

7. The chainsaw sharpening marker apparatus of claim 3, wherein the final mark in each series is designated as a wear limit marker configured to indicate that the cutting tooth has reached its end-of-life threshold.

8. The chainsaw sharpening marker apparatus of claim 1, wherein the aligned marks are applied on both the top face and side face of each cutting tooth to facilitate sharpening from multiple tool orientations.

9. The chainsaw sharpening marker apparatus of claim 1, wherein the sharpening markers on teeth of the first orientation are mirrored in angle and position relative to the sharpening markers on teeth of the second orientation.

10. A chainsaw sharpening marker system comprising:
a chainsaw body including a motor, a guide bar, and a drive mechanism configured to rotate a chainsaw chain along a longitudinal axis;
a chainsaw sharpening marker apparatus, comprising:
a chainsaw chain mounted to the guide bar and configured to travel along the longitudinal axis, the chainsaw chain including a plurality of cutting teeth, the cutting teeth alternating in orientation between a first angle and a second angle relative to the longitudinal axis;
a plurality of sharpening markers, each sharpening marker disposed directly on a corresponding cutting tooth of the chainsaw chain;
wherein each sharpening marker comprises a plurality of aligned marks etched into the surface of the cutting tooth at a predetermined sharpening angle corresponding to the orientation of the tooth;
wherein the aligned marks are positioned such that a first mark is located proximal to a cutting edge of the tooth and at least one subsequent mark is located distal to the cutting edge along the same angular direction;
wherein the aligned marks are disposed at consistent angular orientations for similarly-oriented teeth and at alternating angular orientations for alternately-oriented teeth, configured such that a user visually aligns a sharpening tool with the aligned marks during a sharpening operation to maintain a consistent sharpening angle and to monitor material removal across all cutting teeth.

11. The chainsaw sharpening marker system of claim 10, wherein the aligned marks are laser-etched to a controlled depth that avoids compromising the cutting integrity of each tooth.

12. The chainsaw sharpening marker system of claim 10, wherein the aligned marks comprise one or more series of aligned marks comprising four marks positioned at equal intervals.

13. The chainsaw sharpening marker system of claim 10, wherein the aligned marks comprise one or more series of aligned marks comprising five marks positioned at equal intervals.

14. The chainsaw sharpening marker system of claim 10, wherein the predetermined sharpening angle is approximately 30 degrees and alternates direction with each adjacent cutting tooth.

15. The chainsaw sharpening marker system of claim 10, wherein the aligned marks differ in length to visually indicate a progression of tooth wear.

16. The chainsaw sharpening marker system of claim 12, wherein the final mark in each series is designated as a wear limit marker configured to indicate that the cutting tooth has reached its end-of-life threshold.

17. The chainsaw sharpening marker system of claim 10, wherein the aligned marks are applied on both the top face and side face of each cutting tooth to facilitate sharpening from multiple tool orientations.

18. The chainsaw sharpening marker system of claim 10, wherein the sharpening markers on teeth of the first orientation are mirrored in angle and position relative to the sharpening markers on teeth of the second orientation.

19. (canceled)

20. The chainsaw sharpening marker system of claim 10, wherein at least one sharpening marker comprises a staggered array of L-shaped symbols oriented in alignment with the sharpening angle, configured to visually reinforce angular consistency across alternating cutting teeth.
